(19) United States
(12) Patent Application Publication
(10) Pub. No.: US 2009/0195087 A1
(43) Pub. Date: Aug. 6, 2009

(54) LINEAR ACTUATOR

(75) Inventor: Yuichi KUROSAWA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/365,263

(22) Filed: Feb. 4, 2009

(30) Foreign Application Priority Data
Feb. 4, 2008 (JP) 2008-023803

(51) Int. Cl. H02K 41/03; G02B 7/09

(52) U.S. Cl. 310/12.17; 359/824

(57) ABSTRACT

There is provided a linear actuator, which is provided with a multipolar magnet arranged with a plurality of S-poles and N-poles alternately along an axial direction thereof; and a coiled body arranged to be relatively movable in the axial direction face to face with respect to the multipolar magnet. In this configuration, the multipolar magnet comprises an integrally formed isotropic magnet material which is magnetized into S-poles and N-poles alternately along the axial direction thereof.

### BACKGROUND OF THE INVENTION

The present invention relates to a linear actuator arranged with a magnet and a coil to be capable of linear movement utilizing magnetic force.

Linear actuator is also referred to as linear type motor (linear motor), and is configured to move either of a magnet or a coil utilizing magnetic force which is generated by energizing a coil arranged in a magnetic field generated by a magnet. For example, a linear actuator which is configured that a plurality of permanent magnets are arranged in series face to face with the same polarity each other so as to form a movable element being alternately arranged with S-poles and N-poles, and a coil as a stator is arranged in a magnetic field region generated by the permanent magnets located outer periphery of the movable element, is proposed in Japanese Patent Provisional Publication No. 2007-282475A (hereafter, referred to as JP 2007-282475A). That is, by controlling direction of electric currents to be applied on the coil, a magnetic force in a predetermined direction is generated according to the magnetic field of the permanent magnets, and then the permanent magnets as a movable element is to be linearly moved by the magnetic force. In this regard, the adjacent permanent magnets are adhered because of repulsion of their mutual homopolarity in the permanent magnets.

Japanese Patent Provisional Publication No. H10-313566A (hereafter, referred to as JP H10-313566A) discloses a linear actuator in which a permanent magnet is arranged to be a stator and a coil is arranged to be a movable element, where the stator is configured that a plurality of ring-shaped permanent magnets are inserted in a series between a bracket and a pipe, and adjacent permanent magnets are fayed by tightening of a nut. And, Japanese Published Patent Application No. H9-502597A (hereafter, referred to as JP H9-502597A) of PCT Application discloses a linear actuator in which a coil is arranged to be a stator and a permanent magnet is arranged to be a movable element, similarly to JP 2007-282475A, where a plurality of permanent magnets as a movable element are attached on the peripheral surface of the central shaft side by side at a regular interval along the axial direction.

### SUMMARY OF THE INVENTION

Both of the linear actuators disclosed in JP 2007-282475A and JP H10-313566A have a configuration in which a plurality of permanent magnets are required to be arranged in a series mutually face to face with the same polarity for forming a movable element or a stator by the permanent magnets. Accordingly, the same polar magnetic forces of the adjacent permanent magnets are repelled each other, whereby any fastener means in order to forcibly fix them upon positioning. Therefore, in JP 2007-282475A, the adjacent permanent magnets are adhered using an adhesive or the like. However, its operability is extremely low since the permanent magnets are required to be kept holding radially and axially upon positioning until the adhesive becomes hard for adhering them. In addition, when the adhesive force is weak, problems such as occurrence of displacement and bending deformation, and decreasing in durability caused by loss of faying condition by deterioration of adhesive agent.

In JP H10-313566A, radial and axial positioning is performed by inserting the permanent magnets in a pipe which has a sufficient thickness capable of holding against bending strength thereof, and the same poles of the adjacent permanent magnets are closely fayed by tightening of a nut, therefore it is efficient for improving operability and durability. However, because of existence of a pipe being outside of the permanent magnet, the permanent magnets cannot come very close to the surrounding coil, whereby the magnetic force generated between them becomes low and the driving force of the linear actuator is decreased. Although the plurality of permanent magnets are fixed on the central shaft at a regular interval along the axial direction using an adhesive or the like in JP H9-502597A, each permanent magnet is required to be held at a predetermined position to be adhered because of repelling magnet forces of the adjacent permanent magnets when configuring the linear actuator by fixing the same poles of the adjacent permanent magnets in a closely faying condition as described in JP 2007-282475A and JP H10-313566A, and similar problems to JP 2007-282475A may occur. Additionally, although a configuration of forming the permanent magnet with an isotropic magnet is also disclosed in JP H9-502597A, it has no difference from the case of fixing an ordinary permanent magnet formed with an uniaxial anisotropy magnet in the point of fixing the formed isotropic magnet onto the central shaft, and it cannot solve the problems such as operability and durability described above.

Aspects of the present invention have been made to advantageously provide a linear actuator in which configuration of a multipolar magnet as a stator or a movable element is simplified, operability for forming a multipolar magnet is improved, and excellent durability is achieved.

According to an aspect of the invention, there is provided a linear actuator, which is provided with a multipolar magnet arranged with a plurality of S-poles and N-poles alternately along an axial direction thereof; and a coiled body arranged to be relatively movable in the axial direction face to face with respect to the multipolar magnet. In this configuration, the multipolar magnet comprises an integrally formed isotropic magnet material which is magnetized into S-poles and N-poles alternately along the axial direction thereof.

According to the above described configuration, the multipolar magnet comprises an integrally formed isotropic magnet material which is magnetized into S-poles and N-poles alternately along the axial direction thereof, and in this regard, the multipolar magnet may comprise a multipolar magnetized magnet of a rod-shaped isotropic magnet material formed with a plurality of magnetized regions each of which is magnetized into S-pole and N-pole as their respective two poles at a necessary pitch distance entirely along the axial direction thereof. Therefore, compared to a multipolar magnet composed of a plurality of permanent magnets which are arranged along the axial direction and connected mechanically, reducing parts count, simplifying the configuration, and reduction in weight on actuator are enabled, whereby operability for configuring the multipolar magnet can be improved, and durability against disadvantages caused by deterioration of adhesive agent and the like can be also improved.

In at least one aspect, the multipolar magnet is formed to be a multipolar magnetized magnet of a rod-shaped isotropic magnet material formed with a plurality of magnetized regions each of which is magnetized into S-pole and N-pole as their respective two poles at a predetermined pitch distance along the axial direction thereof.

In at least one aspect, the coiled body comprises a three-phase coil composed of u coil, w coil, and v coil arranged along the axial direction of the multipolar magnetized magnet; and an axial length L of each of the u, w, and v coils is equal to each other, that is a ⅓ length of an axial pitch distance 3 L of each of the magnetized regions being magnetized into S-pole and N-pole in the multipolar magnetized magnet, and is a ½ length of an axial length 2 L of each of the magnetized regions of S-pole and N-pole.

In at least one aspect, the coiled body comprises two three-phase coils composed of six coils being connected along the length direction; and the u coils, w coils, and v coils of the two three-phase coils are respectively arranged to be face to face with the magnetized regions having a different polarity therewith in the multipolar magnetized magnet.

In at least one aspect, the coiled body comprises three three-phase coils composed of nine coils being connected along the length direction; and the three three-phase coils include u coils, w coils, and v coils respectively arranged to be face to face with the magnetized regions having a same polarity therewith in the multipolar magnetized magnet.

In at least one aspect, the u coil, w coil, v coil of the coiled body are connected in one of a Y-connection and a delta connection.

In at least one aspect, the multipolar magnet is arranged as a stator, and the coiled body is arranged as a movable element.

In at least one aspect, the multipolar magnet is arranged as a movable element, and the coiled body is arranged as a stator.

In at least one aspect, the linear actuator is applied to a lens drive mechanism of a camera, and the multipolar magnet is arranged to be extended in a lens optical axis direction of a camera, and the coiled body is arranged to a lens frame.

### BRIEF DESCRIPTION OF THE ACCOMPANYING DRAWINGS

FIGS. 1A and 1B respectively show an external view and a conceptual configuration diagram of a linear actuator according to a first embodiment.

FIGS. 2A and 2B respectively show Y-connection diagrams and an energization timing diagram of a three-phase coil.

FIGS. 3A-3D show conceptual diagrams for illustrating operation of a linear actuator according to the first embodiment.

FIGS. 4A and 4B respectively show delta-connection diagrams and an energization timing diagram of a three-phase coil.

FIGS. 5A-5C respectively show a conceptual configuration diagram, Y-connection diagrams and delta connection diagrams according to a second embodiment.

FIGS. 6A-6C respectively show a conceptual configuration diagram, Y-connection diagrams and delta connection diagrams according to a third embodiment.

FIG. 7 shows an external view of a lens drive mechanism according to a fourth embodiment.

### DETAILED DESCRIPTION OF THE EMBODIMENTS

Hereinafter, embodiments according to the invention are described with reference to the accompanying drawings.

In the following, a coiled body may include two three-phase coils composed of six coils being connected along the length direction; and the u coils, w coils, and v coils of the two three-phase coils are respectively arranged to be face to face with the magnetized regions having different polarity therewith in the multipolar magnetized magnet. Or, the coiled body may include three three-phase coils composed of nine coils being connected along the length direction; and the three three-phase coils include u coils, w coils, and v coils respectively arranged to be face to face with the magnetized regions having a same polarity therewith in the multipolar magnetized magnet. By including a plurality of three-phase coil to configure the actuator as described above, driving force of the actuator can be enhanced multiple times more.

### First Embodiment

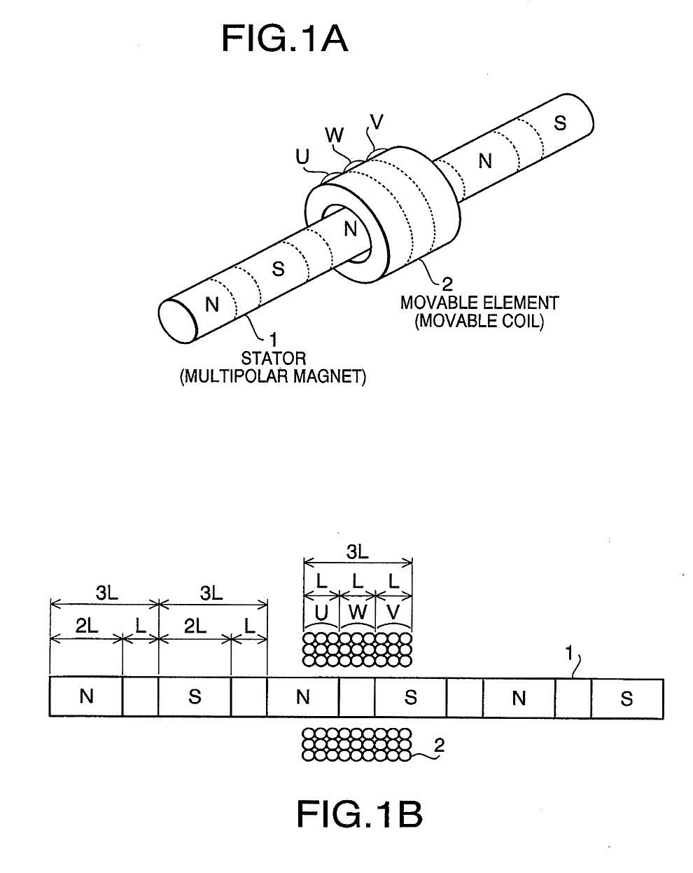

Hereinafter, referring to accompanying drawings, a first embodiment of the present invention will be described. FIG. 1A and FIG. 1B are a conceptual perspective view and a conceptual configuration diagram of a linear actuator according to the invention, respectively. An example of the linear actuator is illustrated here that a cylindrical rod shaped multipolar magnetized magnet 1 is arranged as a stator, and a movable coil 2 as a coiled body of the present invention is arranged as a movable element to be face to face with periphery around the long axis direction of the multipolar magnetized magnet 1 and to move linearly along the length direction of the multipolar magnetized magnet 1.

The multipolar magnetized magnet 1 is formed to be a cylindrical rod shaped isotropic magnet material having a necessary diameter size and length, and is magnetized into S-poles and N-poles alternately at a regular interval along the axis line of the rod, that is, axial direction thereof. When magnetization processing is performed on a non-magnetized cylindrical rod shaped isotropic magnet material sequentially at a predetermined interval along the axial direction thereof, a plurality of magnetized regions each of which is magnetized into S-pole and N-pole as their respective two poles are formed at a predetermined interval along the axial direction thereof. In one of the magnetized regions, the magnetic force at each end portion of the S-pole and N-pole is large. On the contrary, the magnetic force at the middle portion between S-pole and N-pole is too small to practically function as a magnetic pole.

Therefore, a region which has at least a predetermined magnetic force is shown in the figure as S-pole or N-pole, here for descriptive purposes. Accordingly, the multipolar magnetized magnet is configured as a multipolar magnetized permanent magnet in which a plurality of S-poles and N-poles are arranged alternately at a predetermined pitch distance along the axial direction thereof, and lines of magnetic force in the N-pole are directed toward the radial direction with respect to the axis line of the rod-shape of the multipolar magnetized magnet 1, while lines of magnetic force in the S-pole are directed toward the centripetal direction with respect to the axis line thereof.

The movable coil 2 is wound around so as to encircle the multipolar magnetized magnet 1 in a concentric ring shape with respect to the axis line of the rod-shape of the multipolar magnetized magnet 1, and is supported by a portion of a linearly moving body, not shown in the figure. The movable coil 2 is arranged as a three-phase coil composed of an integrated combination of three coils of u coil, w coil, and v coil, which are arranged along the axial direction of the multipolar magnetized magnet 1 here, and each coil of u, v, and w is wound around for each only nine turns (nine winding times) in FIG. 1B for descriptive purposes. The length of each of the u, w, and v coils along the axial direction becomes L, accordingly, the total length of the movable coil 2 becomes 3 L. In turn, the length L of each of the u, w, and v coils is equal to ⅓ of an axial magnetization pitch length 3 L of each of the magnetized regions of S-pole and N-pole magnetized in the multipolar magnetized magnet 1, and is equal to ½ of an axial length 2 L of each of the magnetized regions of S-pole and N-pole.

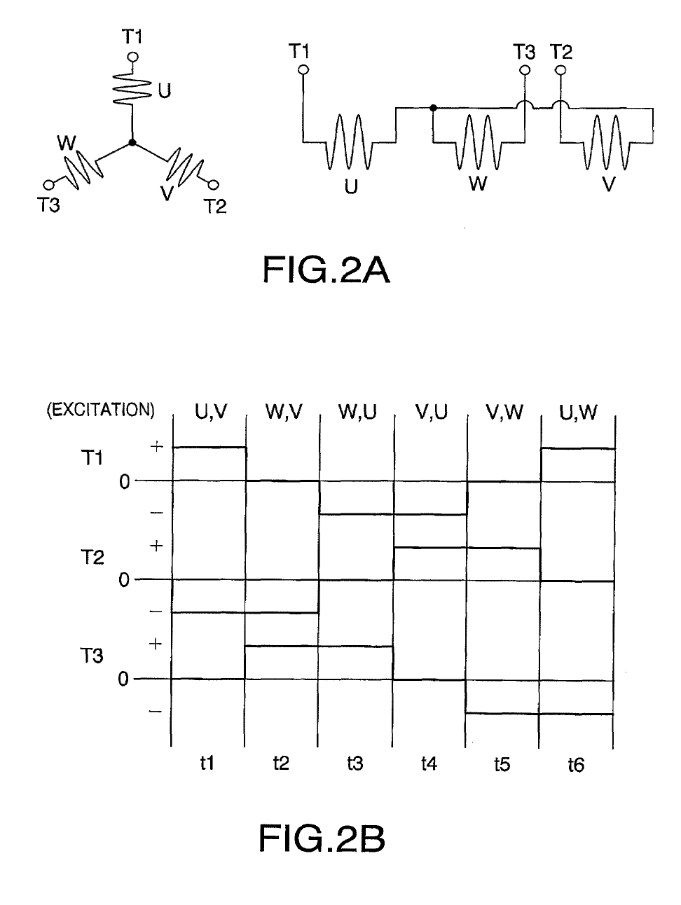

Each one end of the u coil, w coil, and v coil which form the movable coil 2 is connected in union to form a Y-connection as shown in FIG. 2A, and each of the other end is connected to a three-phase power source as electrode terminals T1, T2, and T3 through a controller, not shown in the figure. The controller is configured to apply a positive or negative electric current to each of the coils with a cycle of timing t1 to t6 shown in FIG. 2B, whereby u coil, w coil, and v coil are energized respectively in different phases to form the three-phase coil.

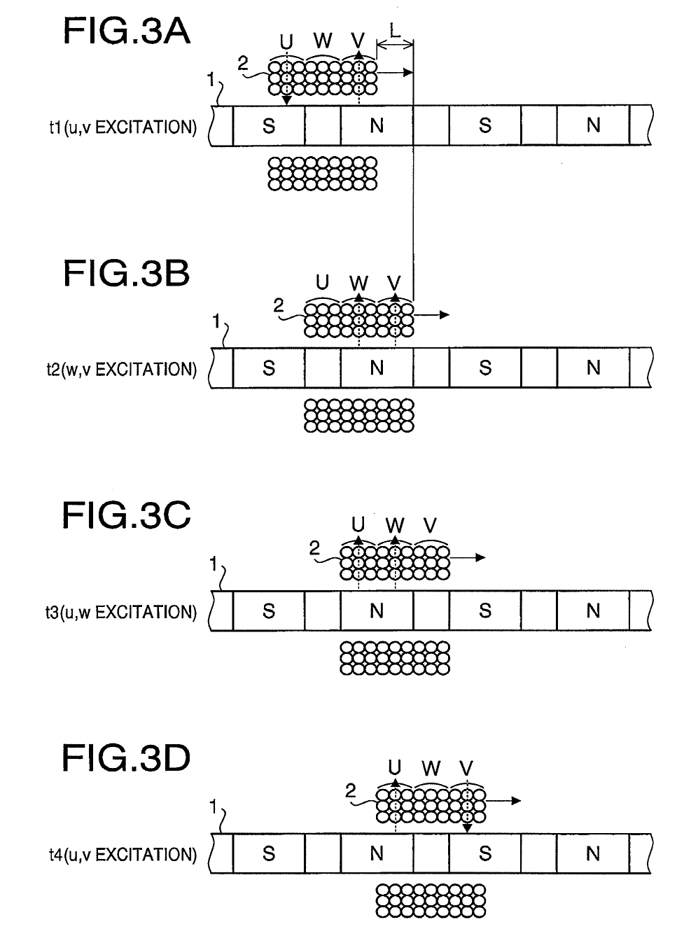

The linear actuator according to the first embodiment, when the movable coil 2 is in the position shown in FIG. 3A, and an electric current at timing t1 shown in FIG. 2B is applied to the u coil, w coil, and v coil of the movable coil 2, the electric current is applied only to the u coil and v coil, and a rightward driving force is generated on these two coils caused by the current directions in the two coils and magnetic fields by S-pole and N-pole of the multipolar magnetized magnet 1 according to the Fleming's left-hand rule, whereby the movable coil 2 moves a distance L to the right. Next, when an electric current at timing t2 shown in FIG. 2B is applied, the electric current is applied only to the w coil and v coil shown in FIG. 3B, and a rightward driving force is generated on these two coils caused by the current directions in the two coils and magnetic fields by N-pole of the multipolar magnetized magnet 1 according to the Fleming's left-hand rule, whereby the movable coil 2 moves another distance L to the right.

Then, when an electric current at timing t3 shown in FIG. 2B is applied, the electric current is applied only to the w coil and u coil as shown in FIG. 3C, and a rightward driving force is generated on these two coils caused by the current directions in the two coils and magnetic fields by N-pole of the multipolar magnetized magnet 1 according to the Fleming's left-hand rule, whereby the movable coil 2 moves further distance L to the right. Accordingly, the movable coil 2 is to be moved distance 3 L to the right by energization control in the half cycle. Furthermore, when an electric current at timing t4 shown in FIG. 2B is applied, the electric current is applied only to the v coil and u coil as shown in FIG. 3D, and a rightward driving force is generated on these two coils caused by the current directions in the two coils and magnetic fields by N-pole and S-pole of the multipolar magnetized magnet 1 according to the Fleming's left-hand rule, whereby the movable coil 2 moves still further distance L to the right.

In a similar manner, by energizing at timing t5 and t6, though illustration is omitted, the three-phase coil still furthermore moves to the right, consequently, the movable coil 2 is to be moved distance 6 L to the right in one cycle from timing t1 to t6. In this regard, when energization control is performed in the direction from timing t6 to t1 shown in FIG. 2B, the movable coil 2 is to be moved distance 6 L to the left, that is, the opposite direction of the direction described above, in one cycle of current control. Thus, linear reciprocating movement control of the movable coil 2, that is, the movable element, can be performed along the multipolar magnetized magnet 1, whereby the linear actuator is to be configured.

In the first embodiment as described above, the multipolar magnet as a stator is formed with the multipolar magnetized magnet 1 which is magnetized so as to form alternate magnetic poles along the length direction onto a rod-shaped isotropic magnet material. Therefore, compared to the multipolar magnets disclosed in JP 2007-282475A, JP H10-313566A and JP H19-502597A those are respectively composed of a plurality of magnets which are individually magnetized and connected mechanically, the multipolar magnet in the first embodiment can be formed with a single magnet material. Consequently, the multipolar magnet can be produced at low cost by reducing parts count, without the necessity of configuration for connecting a plurality of magnets to unite them, that allows configuration of the multipolar magnet as a stator to be simplified so that reduction in size and weight can be achieved, and operability for configuring the multipolar magnet can be improved. In addition, since there is no problem involved in adhering separate magnets such as occurrence of displacement and bending deformation caused by lowering of adhesive force, and decreasing in durability caused by deterioration of adhesive agent, whereby a long life linear actuator can be obtained.

For producing the multipolar magnetized magnet 1 configured as above, the magnetized regions of S-poles and N-poles arranged along the axial direction can be formed at an optional pitch distance and in an optional length regions along the axial direction by performing magnetization onto an isotropic magnet material at an optional pitch distance. Accordingly, configuration of u coil, w coil, and v coil which compose the three-phase coil to be respectively arranged face to face with S-pole, N-pole, and a region between them in the multipolar magnetized magnet 1 can be realized, and the above-described linear driving becomes enabled. Especially, when using an existing coil for the movable coil 2, it is easy to produce a multipolar magnet by adapting the magnetized regions and pitch length conforming to the standard of the movable coil, whereby design and produce of the linear actuator can be performed easily. Also, by designing the magnetized regions and pitch length optionally, a linear actuator in which one pitch movement length of the movable element can be optionally designed become enabled.

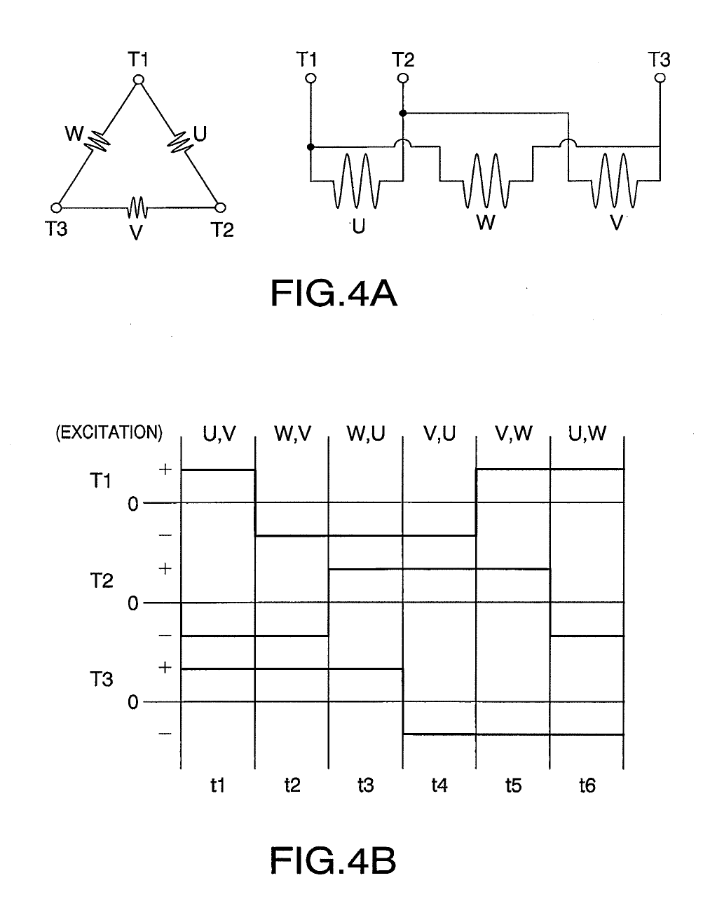

In this regard, as for the u coil, w coil, and v coil of the movable coil 2, each one end of the u coil, w coil, v coil may be connected in a ring shape to form a delta connection as shown in FIG. 4A, and each of the terminals T1, T2, and T3 may be connected to a three-phase power source through a controller, not shown in the figure. In this case, by applying a positive or negative electric current to each of the coils from timing t1 to t6 as one cycle shown in FIG. 4B, linear reciprocating movement control of the movable coil 2 can be performed distance 6 L to the right or to the left in one cycle similarly to the above description according to FIG. 3.

### Second Embodiment

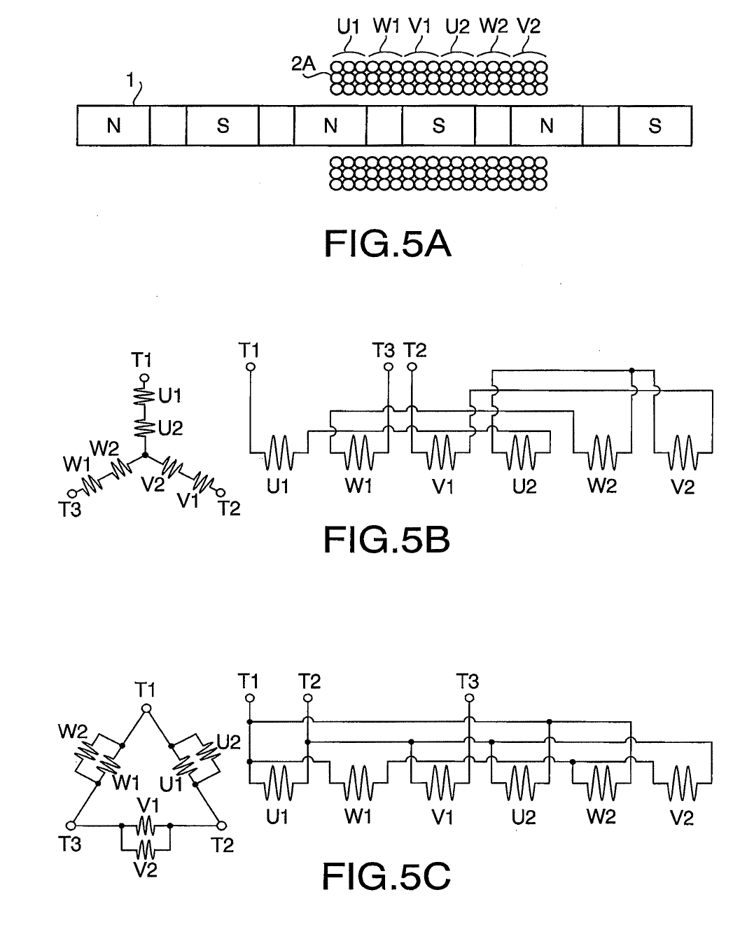

FIG. 5A is a conceptual configuration diagram of a linear actuator according to a second embodiment. Configuration of a multipolar magnetized magnet 1 as a multipolar magnet is the same as that in the first embodiment. As for a movable coil 2A as a coiled body of the present invention, two three-phase coils, each of which is similar to the three-phase coil in the first embodiment, are connected along the axial direction to form the movable coil 2A. Although the respective length along the axial direction and the number of winding turns of the respective three coils of u coil, w coil, and v coil forming the three-phase coil are the same as those of the first embodiment, here in the six coils forming the two three-phase coils, two u coils (u1 coil and u2 coil), two v coils (v1 coil and v2 coil), and two w coils (w1 coil and w2 coil) are arranged side by side along the axial direction. That is, the six coils are arranged in the order of u1 coil, w1 coil, v1 coil, u2 coil, w2 coil, and v2 coil from left to right in FIG. 5A. In this regard, each of the u, w, and v coils is arranged to be face to face with a magnetic pole having different polarity of S-pole or N-pole of the multipolar magnetized magnet 1. And, the u1 coil and u2 coil, the w1 coil and w2 coil, and the v1 coil and v2 coil are respectively connected in series and then connected to form a Y-connection as shown in FIG. 5B so as to be connected to a power source through a controller.

In the linear actuator according to the second embodiment, although the linear movement operation of the movable coil 2A is basically the same as the operation in the first embodiment described in FIG. 3, energization on the two three-phase coils becomes symmetric operation according to the symmetric arrangement of each of the u, w, and v coils. For example, when the movable coil 2A is in the position shown in FIG. 5A, and an electric current at timing t1 shown in FIG. 2B is applied to the u1 coil, u2 coil, w1 coil, w2 coil, v1 coil, and v2 coil, a rightward driving force is generated on the u1 coil by magnetic field of one N-pole in the multipolar magnetized magnet 1, and a rightward driving force is generated on the u2 coil by magnetic field of another S-pole in the multipolar magnetized magnet 1. At the same time, a rightward driving force is generated on the v1 coil by magnetic field of one S-pole, and a rightward driving force is generated on the v2 coil by magnetic field of the same N-pole.

Therefore, energization on each of the six coils of u, w, and v coils forming the two three-phase coils causes magnetic fields of another S-pole or N-pole, whereby driving force is to be generated. The succeeding processes on timing t2 to t6 are the same as above. Thus, in a similar manner to the first embodiment, the movable coil 2A is to be moved distance 6 L to the right in one cycle from timing t1 to t6 shown in FIG. 2B. It is also the same that when the control is performed in the direction from timing t6 to t1, the movable coil 2A can be moved distance 6 L to the left in one cycle of current control. In the second embodiment, since four coils of the total of six coils of u, w, and v coils generate driving force in each of the timing t1 to t6, a linear actuator having double the driving force of the first embodiment can be configured. Since the multipolar magnetized magnet 1 is configured by performing multipolar magnetization onto an isotropic magnet material also in the linear actuator according to the second embodiment, a long life and highly reliable linear actuator can be configured while reducing parts count, simplifying the configuration, and improving operability.

In this regard, the u1 coil, u2 coil, w1 coil, w2 coil, v1 coil, and v2 coil of the movable coil 2 may be connected to form a delta connection as shown in FIG. 5C and then may be connected to a three-phase power source through a controller. In this case, by applying a positive or negative electric current to the u coils, w coils, and v coils at timing shown in FIG. 4B, linear reciprocating movement control of the movable coil can be performed distance 6 L to the right or to the left in one cycle similarly to the above.

### Third Embodiment

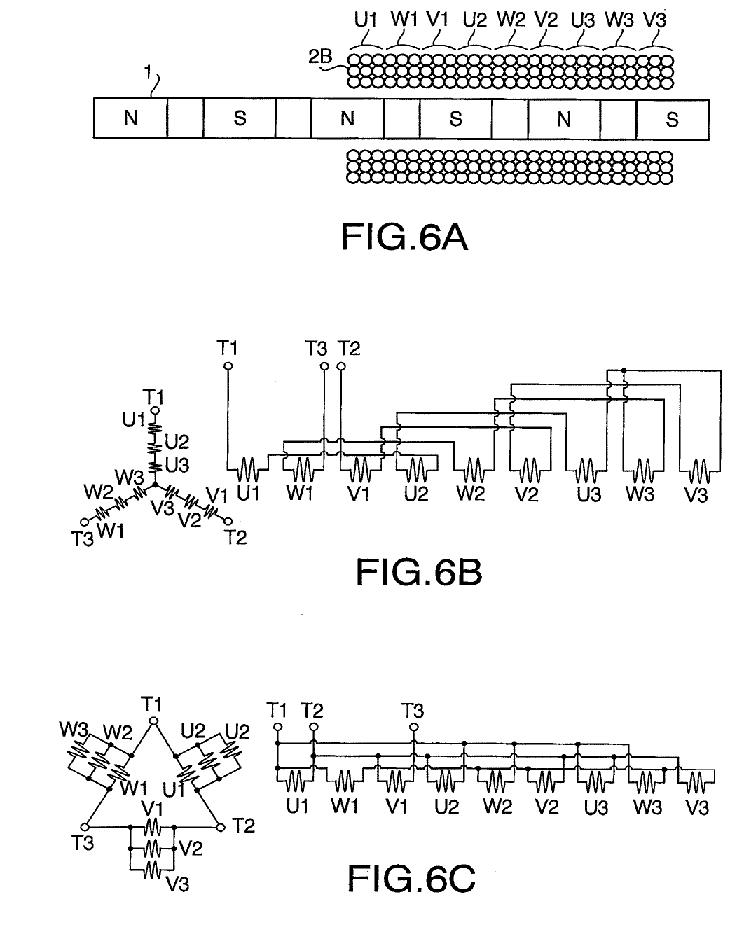

FIG. 6A is a conceptual configuration diagram of a linear actuator according to a third embodiment. Configuration of a multipolar magnetized magnet 1 as a multipolar magnet is the same as that in the first embodiment. As for a movable coil 2B, nine coils forming the movable coil 2B are configured that three three-phase coils are connected along the axial direction. Although the respective length along the axial direction and the number of winding turns of the respective three coils of u coil, w coil, and v coil forming the three-phase coil are the same as those of the first embodiment, here in the respective u coils (u1 coil, u2 coil, and u3 coil), v coils (v1 coil, v2 coil, and v3 coil), and w coils (w1 coil, w2 coil, and w3 coil) of the three three-phase coils: u1, u2, and u3 coils; w1, w2, and w3 coils; and v1, v2, and v3 coils; are arranged in the same order along the axial direction. That is, the coils are arranged in the order of u1 coil, w1 coil, v1 coil, u2 coil, w2 coil, v2 coil, u3 coil, w3 coil, and v3 coil from left to right in the figure. Consequently, each of the (u1 and u3), (w1 and w3), and (v1 and v3) coils is arranged to be face to face with a magnetic pole having the same polarity of S-pole or N-pole of the multipolar magnetized magnet 1. And, the u1, u2, and u3 coils; w1, w2, and w3 coils; and v1, v2, and v3 coils are respectively connected in series and then connected to form a Y-connection as shown in FIG. 6B so as to be connected to a power source.

In the linear actuator according to the third embodiment, although the linear movement operation of the movable coil 2B is basically the same as the operation in the first embodiment described in FIG. 3, energizating direction on nine coils forming the three three-phase coils becomes the same or opposite according to the arrangement of the coils. For example, when the movable coil 2B is in the position shown in FIG. 6A, and an electric current at timing t1 shown in FIG. 2B is applied to the u1 to u3 coils, w1 to w3 coils, and v1 to v3 coils, a rightward driving force is generated on the u1 coil by magnetic field of one N-pole in the multipolar magnetized magnet 1, and also respectively rightward driving forces are generated on the u2 coil by magnetic field of oppositely provided S-pole and on the u3 coil by magnetic field of another N-pole. At the same time, a rightward driving force is generated on the v1 coil by magnetic field of one S-pole, and also respectively rightward driving forces are generated on the v2 coil by magnetic field of the adjacent N-pole, and on the v3 coil by magnetic field of another S-pole.

Therefore, energization on each of the nine coils of u, w, and v coils forming the three three-phase coils causes magnetic field of S-pole or N-pole, whereby each driving force is to be generated. The succeeding processes on timing t2 to t6 are the same as above. Thus, in a similar manner to the first embodiment and the second embodiment, the movable coil 2B is to be moved distance 6 L to the right in one cycle from timing t1 to t6 shown in FIG. 2B. It is also the same that when the control is performed in the direction from timing t6 to t1, the movable coil 2B can be moved distance 6 L to the left in one cycle of current control. In the third embodiment, since driving force is generated respectively in six coils of the total of nine coils of the u, w, and v coils at each of the timing t1 to t6, a linear actuator having triple the driving force of the first embodiment can be configured. Since the multipolar magnetized magnet 1 is configured by performing multipolar magnetization onto an isotropic magnet material also in the linear actuator according to the third embodiment, a long life and highly reliable linear actuator can be configured while simplifying the configuration, and improving operability.

In this regard, the u1 coil, u2 coil, u3 coil, w1 coil, w2 coil, w3 coil, v1 coil, v2 coil, and v3 coil may be connected to form a delta connection as shown in FIG. 6C and then may be connected to a three-phase power source through a controller. In this case, by applying a positive or negative electric current to the u coils, w coils, and v coils at timing shown in FIG. 4B similarly to the first embodiment, linear reciprocating movement control of the movable coil can be performed distance 6 L to the right or to the left in one cycle similarly to the above.

### Fourth Embodiment

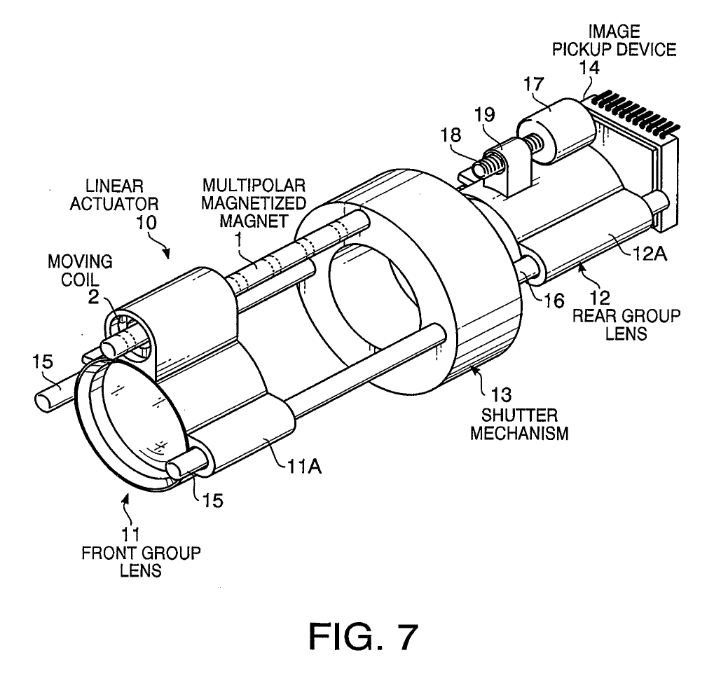

FIG. 7 is a conceptual configuration perspective view according to a fourth embodiment in which a linear actuator according to any one of the first, second, and third embodiments is applied to a lens mechanism of a digital camera. Front group lenses 11, a shutter mechanism 13, and rear group lenses 12 are disposed on the optical axis thereof, further, an image pickup device 14 is disposed behind rear group lenses 12 in a camera body, not shown in the figure. Though it comes near to stating the obvious, according to the lens mechanism, when the shutter mechanism 13 is operated of open action, a subject image is taken by the front group lenses 11 and the rear group lenses 12, and is formed in the image pickup device 14. The front group lenses 11 and the rear group lenses 12 are configured to incorporate necessary shape and number of lenses respectively in the front group lens frame 11A and the rear group lens frame 12A, which are movably supported by a pair of (two) lens frame guides 15 and 16 respectively in the optical axis direction.

Here, a linear actuator 10 according to the first embodiment is employed as a drive mechanism for the front group lenses 11. In this regard, each cylindrical rod shaped multipolar magnetized magnet 1 is disposed extending from the shutter mechanism 13 toward the front, and each movable coil 2 which is disposed surrounding the multipolar magnetized magnet 1 is fixed to the front group lens frame 11A. The movable coil 2 is, needless to mention, formed as a three-phase coil composed of u coil, v coil, and w coil as shown in FIG. 1, each of the coils is to be under an energization control similarly to the first embodiment through a wiring, not shown in the figure. And in this embodiment, a stepping motor 17, which is supported by a camera body to be under a rotation control by a motor drive circuit, not shown in the figure, is employed as a movement mechanism of the rear group lenses 12 in the optical axis direction thereof. A lead screw 18 is integrally provided on a rotary shaft of the stepping motor 17, and a movable nut 19, which is threadably engaged with the lead screw 18 to be moved with the rotation thereof in the optical axis direction, is fixed at a portion of the rear group lens frame 12A

According to the lens mechanism, amount of rotation of the lead screw 18 is controlled under a control of rotation angle of the stepping motor 17 by a motor drive circuit, the movable nut 19, which is threadably engaged with the lead screw 18, is moved along the lead screw 18 in the optical axis direction, and the rear group lens frame 12A, which is integrated with the movable nut 19, is moved along the lens frame guide 16 in the optical axis direction, whereby position along the optical axis direction of the rear group lenses 12 is controlled. As for the front group lenses 11, position along the optical axis direction of the movable coil 2 with respect to the multipolar magnetized magnet I is shifted as described in the first embodiment under the control of electric current to be applied to the movable coil 2 which composes linear actuator 10, and the front group lens frame 11A, which is integrated with the movable coil 2, is moved along the lens frame guide 15 in the optical axis direction, whereby position along the optical axis direction of the front group lenses 11 is controlled. Consequently, zoom control and focus control of the lens mechanism by controlling the front group lenses 11 and the rear group lenses 12 toward a desired position along the optical axis direction, thus image forming by the image pickup device 14 becomes enabled.

According to the fourth embodiment, since the linear actuator 10 having the configuration described in the first embodiment is adopted as the drive mechanism of the front group lenses 11, a drive mechanism such as the stepping motor 17 for the rear group lenses 12 is unnecessary, and is allowed to be configured of only the multipolar magnetized magnet 1 and the movable coil 2, thereby becoming advantageous for reduction in size and weight. Especially, since the multipolar magnetized magnet 1 is configured by performing multipolar magnetization onto a rod-shaped isotropic magnet material, a long life and highly reliable lens drive mechanism can be obtained while simplifying the configuration of the multipolar magnetized magnet as a stator aiming to reduce in size and weight, improving operability for configuring the multipolar magnet, without having problems such as occurrence of displacement and bending deformation caused by lowering of adhesive force, and decreasing in durability caused by deterioration of adhesive agent.

Although each of the first to fourth embodiments shows a linear actuator in which a multipolar magnetized magnet is arranged as a stator and a coil is arranged as a movable element, a linear actuator in which a coil is arranged as a stator and the multipolar magnetized magnet is arranged as a movable element can be also obtained. When the multipolar magnetized magnet is arranged as a movable element as described above, configuration of the movable element can be simplified and reduced in weight by configuring the multipolar magnetized magnet with an integrally formed isotropic magnet material, whereby a linear actuator having excellent movement responsiveness compared to conventional linear actuators in which the multipolar magnet is arranged with a plurality of magnets being connected to be a movable element.

This application claims priority of Japanese Patent Application No. P2008-023803, filed on Feb. 4, 2008. The entire subject matter of the application is incorporated herein by reference.

What is claimed is:

1. A linear actuator comprising:
a multipolar magnet arranged with a plurality of S-poles and N-poles alternately along an axial direction thereof, and
a coiled body arranged to be relatively movable in the axial direction face to face with respect to the multipolar magnet,
wherein the multipolar magnet comprises an integrally formed isotropic magnet material which is magnetized into S-poles and N-poles alternately along the axial direction thereof.

2. The linear actuator according to claim 1, wherein the multipolar magnet is formed to be a multipolar magnetized magnet of a rod-shaped isotropic magnet material formed with a plurality of magnetized regions each of which is magnetized into S-pole and N-pole as their respective two poles at a predetermined pitch distance along the axial direction thereof.

3. The linear actuator according to claim 2, wherein the coiled body comprises a three-phase coil composed of u coil, w coil, and v coil arranged along the axial direction of the multipolar magnetized magnet; and an axial length L of each of the u, w, and v coils is equal to each other, that is a ⅓ length of an axial pitch distance 3 L of each of the magnetized regions being magnetized into S-pole and N-pole in the multipolar magnetized magnet, and is a ½ length of an axial length 2 L of each of the magnetized regions of S-pole and N-pole.

4. The linear actuator according to claim 3, wherein the coiled body comprises two three-phase coils composed of six coils being connected along the length direction; and the u coils, w coils, and v coils of the two three-phase coils are respectively arranged to be face to face with the magnetized regions having a different polarity therewith in the multipolar magnetized magnet.

5. The linear actuator according to claim 3, wherein the coiled body comprises three three-phase coils composed of nine coils being connected along the length direction; and the three three-phase coils include u coils, w coils, and v coils respectively arranged to be face to face with the magnetized regions having a same polarity therewith in the multipolar magnetized magnet.

6. The linear actuator according to claim 3, wherein the u coil, w coil, v coil of the coiled body are connected in one of a Y-connection and a delta connection.

7. The linear actuator according to claim 1, wherein the multipolar magnet is arranged as a stator, and the coiled body is arranged as a movable element.

8. The linear actuator according to claim 1, wherein the multipolar magnet is arranged as a movable element, and the coiled body is arranged as a stator.

9. The linear actuator according to claim 7, wherein the linear actuator is applied to a lens drive mechanism of a camera, and the multipolar magnet is arranged to be extended in a lens optical axis direction of a camera, and the coiled body is arranged to a lens frame.
